(19) United States
(12) Patent Application Publication
(10) Pub. No.: US 2025/0207706 A1
(43) Pub. Date: Jun. 26, 2025

(54) Manifolds for Use with Insertable or Installable Valves

(71) Applicant: Relativity Space, Inc., Long Beach, CA (US)

(72) Inventors: Sophia Granovskaya Martinez, Long Beach, CA (US); Shenwei Chen, Long Beach, CA (US); Max Kwon, Long Beach, CA (US); Jack Grooms, Long Beach, CA (US)

(73) Assignee: Relativity Space, Inc., Long Beach, CA (US)

(21) Appl. No.: 19/000,452

(22) Filed: Dec. 23, 2024

Related U.S. Application Data
(60) Provisional application No. 63/614,225, filed on Dec. 22, 2023.

(51) Int. Cl. F16L 41/03; F16K 11/07

(52) U.S. Cl. CPC F16L 41/03; F16K 11/07; F16K 2200/501

(57) ABSTRACT

A fluid manifold can be produced with additive manufacturing. The manifolds can tolerate a range of temperatures, pressures, and/or fluid flow speeds, and are compatible with a variety of fluids and/or gases. The fluid manifold can receive an insertable or installable valve, such as a cartridge valve.

### CROSS REFERENCE TO RELATED APPLICATIONS

The current application claims the benefit of and priority under 35 U.S.C. 119 (e) to U.S. Provisional Patent Application No. 63/614,225 filed Dec. 22, 2023, the disclosure of which is incorporated herein by reference in its entirety.

### FIELD OF THE INVENTION

This application generally refers to manifolds for use with valves. More specifically, this application relates to additive manufacturing manifolds for use with valves.

### BACKGROUND

Some manifolds are designed with a central bore or cavity specifically configured to accommodate an insertable or installable valve, commonly known as a cartridge valve. These cartridge valves often have a cylindrical shape and operate through solenoid actuation. Cartridge valves are frequently utilized because they allow for precise control in various applications. Cartridge valves are also known as “bodiless” valves because they are designed to be inserted into a manifold's cavity without the need for separate housing. As a result, in many applications cartridge valves can simplify the assembly and maintenance of fluid control systems while providing efficient functionality in directing the flow of liquids or gases.

### SUMMARY OF THE INVENTION

Systems and methods in accordance with some embodiments of the invention are directed to cartridge valve manifolds.

Many embodiments of the disclosure are directed to a fluid manifold, including: a cavity having an annular wall; a plurality of valve receptacles each including a sloped ridge disposed within the annular wall and at least one fluid opening disposed along the sloped ridge; and a plurality of main fluid lines, each of the plurality of main fluid lines in fluid communication with one of at least one fluid opening of at least one of the plurality of valve receptacles via at least one of a plurality of sub-fluid lines, the plurality of sub-fluid lines being in fluid communication therebetween; wherein the fluid manifold is configured for additive manufacturing and the sloped ridge is compliant with a design-for-additive-manufacturing constraint.

In many embodiments, at least one of the plurality of valve receptacles is configured to engage with a cartridge valve and seat the cartridge valve when the cartridge valve is disposed within the cavity.

In many embodiments, the cartridge valve is further configured to lock in place when engaged by at least one of the plurality of valve receptacles.

In many embodiments, the cartridge valve includes a plurality of ports and each of the at least one fluid opening of the plurality of valve receptacles is configured to engage with at least one of the plurality of ports.

In many embodiments, the fluid manifold includes three valve receptacles and three main fluid lines.

In many embodiments, each of the main fluid lines is in fluid communication with three sub-fluid lines.

In many embodiments, the cartridge valve further includes a gasket and at least one sloped ridge is configured to reduce damage to the gasket.

In many embodiments, the fluid manifold is configured for a fluid flow selected from the group consisting of a liquid flow, a gaseous flow, or a mixture of a liquid flow and a gaseous flow.

In many embodiments, the fluid flow includes a fluid selected from the group consisting of: a liquid fuel for engines or launch vehicles, a gaseous fuel for engines or launch vehicles, an igniter gas for engines, an inert gas, a cooling liquid, a cooling gas, a cryogenic liquid, a cryogenic gas, a cryogenic inert gas, liquid oxygen, cryogenic liquid oxygen, liquid hydrogen, cryogenic liquid hydrogen, kerosene, hydrazine, and hydrogen peroxide.

Many embodiments of the disclosure are directed to an article including: a central cavity having a plurality of annular cavity walls disposed around a central axis, wherein the plurality of annular cavity walls are disposed at a first radial distance from the central axis; at least one valve receptacle recessed within the central cavity, the at least one valve receptacle including an annular receptacle wall disposed at a second radial distance from the central axis, the second radial distance being greater than the first radial distance; the at least one valve receptacle further having a pair of annular sloped ridges connecting the annular receptacle wall of the at least one valve receptacle with at least one adjacent annular cavity wall; a plurality of fluid openings disposed in the annular receptacle wall of the at least one valve receptacle, each fluid opening having a teardrop cross-section oriented such that an axis of the teardrop cross-section is arranged in a direction parallel to the central axis of the central cavity; and a plurality of sub-fluid lines in fluid communication between the plurality of fluid openings and at least one main fluid line.

In many embodiments, at least one of the plurality of sub-fluid lines is co-axial with the at least one main fluid line.

In many embodiments, at least one of the plurality of sub-fluid lines is disposed along a curved path between the at least one main fluid line and the central cavity.

In many embodiments, the at least one main fluid line is configured with a uniform cross-section geometry across a length of the at least one main fluid line.

In many embodiments, the at least one main fluid line is configured with a cross-section geometry selected from the group consisting of: teardrop shape, circular, ovular, and polygon.

In many embodiments, a degree of slope of an edge of the teardrop cross-section is compliant with a design-for-additive-manufacturing constraint.

In many embodiments, a degree of slope of the pair of annular sloped ridges is compliant with a design-for-additive-manufacturing constraint.

In many embodiments, each of the plurality of fluid openings spans substantially all of the annular receptacle wall between the annular sloped ridges.

In many embodiments, the article, further includes a cartridge valve configured to be inserted in and disposed within the central cavity.

In many embodiments, the cartridge valve includes a port and the cartridge valve and the central cavity are further configured such that the port of the cartridge valve is aligned opposite the valve receptacle when the cartridge valve is disposed within the central cavity.

Many embodiments of the disclosure are directed to a fluid manifold, including: a cavity having an annular wall; three valve receptacles each including a sloped ridge disposed within the annular wall and at least one fluid opening disposed along the sloped ridge; three main fluid lines each in fluid communication with one of the at least one fluid opening of at least one of the three valve receptacles via at least one of a plurality of sub-fluid lines, the plurality of sub-fluid lines being in fluid communication therebetween; and a cartridge valve including a plurality of ports and at least one gasket; wherein each of the three valve receptacles is configured to engage with the cartridge valve and seat the cartridge valve when the cartridge valve is disposed within the cavity, each of the at least one fluid opening is configured to engage with at least one of the plurality of ports, the cartridge valve is configured to lock in place when engaged by at least one of the three valve receptacles, and each sloped ridge is configured to reduce damage to the at least one gasket.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which include embodiments of the invention and should not be construed as a complete recitation of the scope of the invention, wherein:

FIGS. 1A through 1C illustrate a solenoid actuated cartridge valve in accordance with prior art.

FIG. 2A illustrates a prospective view of a fluid manifold in accordance with an embodiment.

FIG. 2B illustrates a cross section view of the fluid manifold in accordance with an embodiment.

FIG. 3A illustrates the interaction between the gaskets of a cartridge valve and a manifold with sharp edges in accordance with an embodiment.

FIG. 3B illustrates an enlarged view of a manifold with sloped ridges in accordance with an embodiment.

FIG. 3C illustrates the interaction between the gaskets of a cartridge valve and a manifold with sloped ridges in accordance with an embodiment.

FIG. 4A illustrates a comparison between the sharp edges and the sloped ridges of a manifold in accordance with an embodiment.

FIGS. 4B through 4D illustrate various cross section views of the manifold in accordance with an embodiment.

### DETAILED DESCRIPTION OF THE INVENTION

Conventional Vs. Additive Manufacturing

Conventionally, manifolds are manufactured using casting and/or machining. Casting and machining are desirable techniques because they have a strong legacy in manufacturing. Recently, some part builders have started utilizing additive manufacturing techniques such as laser powder bed fusion, also known as direct metal laser sintering, to manufacture manifolds. An additively manufactured manifold can, in some instances, offer equivalent performance as a conventionally manufactured manifold, sometimes with lower part count, part complexity, and/or weight. Lower part count, lower part complexity, and lower weight are often not the compelling need that drives manifold design. Notably, additive manufacturing lacks the strong, repeatable, well understood legacy of conventional manufacturing and the wide availability of tool makers and machinists. Additive manufacturing may, in fact, increase costs. Put simply, the decision to use conventional vs. additive manufacturing for building a manifold is not an intuitive or obvious one.

Nevertheless, as noted above, additive manufacturing is a known technology for manufacturing manifolds. For purposes of the disclosure, additive manufacturing (AM), printing, and/or 3D printing are used interchangeably to refer to a computer-controlled process that creates three dimensional objects by adding layers of material (layer-by-layer) to create the final object.

### Insertable/Installable Valves

Cartridge valves can be suitable for use with additively manufactured manifolds because, as noted above, cartridge valves can be inserted into a cavity and are not within their own integral housing. Cartridge valves can be three-way two-position valves with a normally open (NO) port, a cycle (CYL) port, and a normally closed (NC) port.

An additively manufactured manifold can be designed to include a plurality (such as two; or three; or four; or five) of valve receptacles, each corresponding to a cartridge valve port. In many embodiments, each valve receptacle of the manifold can host a plurality of fluid lines to achieve the desired fluid flow pressure and/or speed. The manifolds in accordance with some embodiments can be used for fluid control in various aerospace related applications, such as (but not limited to) launch vehicles and/or rocket engines.

The manifolds can be made of various materials such as (but not limited to) metallic materials, metals, metal alloys, composites, polymers, resins, and any combinations thereof. In at least one embodiment, the manifold can be a monolithic structure; that is, it is not formed from multiple pieces that are joined together, it is not a combination of materials, and it is instead a single material. Various types of liquids and/or gases are compatible with the cartridge valve manifolds in accordance with several embodiments. The fluid line materials are selected to be non-reactive with the liquids and/or gases to prevent fluid line damages, degradation, corrosions, and/or leakage. The sizes and/or diameters of the fluid lines can be selected to provide desired pressures of the flows. For purposes of this disclosure, fluid lines refer the main fluid lines and/or sub-fluid lines of the manifold unless specifically described. Any type of a liquid and/or a gas flow can be controlled using the manifolds. Examples of liquids and/or gases include (but are not limited to) liquid flows, gaseous flows, liquid and/or gaseous fuels for engines and/or launch vehicles, igniter gases for engines, inert gases, cooling liquids and/or gases, cryogenic liquids, cryogenic gases, cryogenic inert gases, (cryogenic) liquid oxygen, (cryogenic) liquid hydrogen, kerosene, hydrazine, and/or hydrogen peroxide.

The manifolds and the fluid lines in accordance with many embodiments can tolerate a range of temperatures, pressures, and/or flow speeds. The materials of the fluid lines are selected to tolerate the working temperatures, pressures, and/or flow speeds of the manifolds. Examples of temperature range include (but are not limited to) from about −150 degrees Fahrenheit to about 200 degrees Fahrenheit; from about −150 degrees Fahrenheit to about 150 degrees Fahrenheit; from about −100 degrees Fahrenheit to about 200 degrees Fahrenheit; from about −100 degrees Fahrenheit to about 150 degrees Fahrenheit; from about −65 degrees Fahrenheit to about 200 degrees Fahrenheit; from about −65 degrees Fahrenheit to about 150 degrees Fahrenheit; from about −50 degrees Fahrenheit to about 200 degrees Fahrenheit; from about −50 degrees Fahrenheit to about 150 degrees Fahrenheit. Examples of pressure range include (but are not limited to) from about 5000 psi to about 15,000 psi; from about 5000 psi to about 14,000 psi; from about 5000 psi to about 13,000 psi; from about 5000 psi to about 12,000 psi; from about 5000 psi to about 11,000 psi; from about 5000 psi to about 10,000 psi.

A cartridge valve can be actuated by solenoids. See, e.g., U.S. Provisional Patent Application No. 63/585,871 filed Sep. 27, 2023, the disclosure of which is incorporated by reference. As described in the incorporated material, the cartridge style valves include a solenoid and a valve body. The valve body can be plugged into the 3D printed manifold. The valve body and the manifold can be secured using various methods such as (but not limited to) threaded connections, locking tabs, and/or locking pucks.

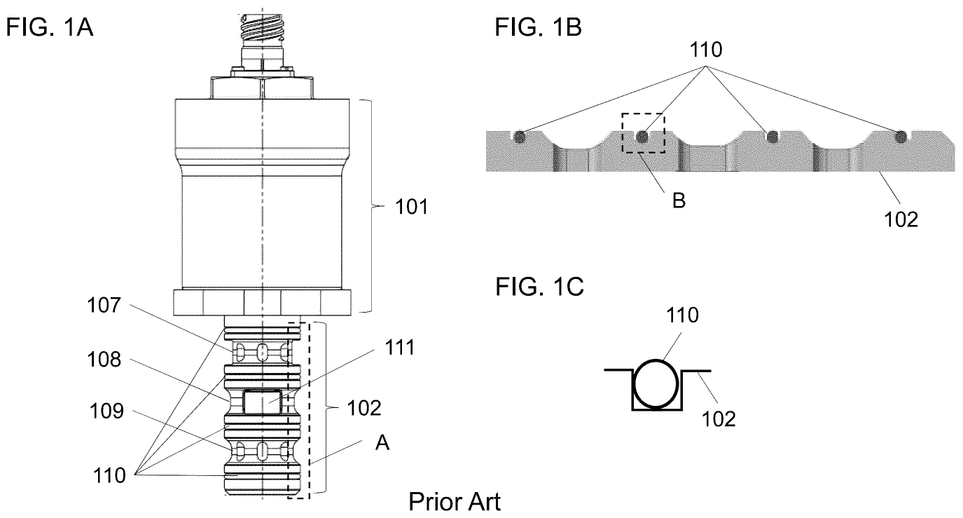

FIG. 1A illustrates a side view of an example solenoid operated cartridge valve that can be utilized with a compliant manifold. The solenoid valve comprises a solenoid part 101 and a valve body 102. The valve body 102 can be a cartridge style valve and can be inserted in to a fluid manifold. The valve body 102 can be a three-way two-position valve with a normally open (NO) port 107, a cycle (CYL) port 108, and a normally closed (NC) port 109. The fluid inlet tubes (not shown) for the NO port 107, the CYL port 108, and the NC port 109 can be aligned in the same direction or in different directions. The directions of the fluid inlet tubes can be selected to enable a compact and functional manifold structure.

Gaskets such as O-rings 110 are positioned on the flow path 102 for sealing and preventing leaks. A seat 111, also known as a main seat, a soft seat, or a seat ring in the lumen of the valve body 102, can be controlled via the solenoid 101 to control the fluid flow through the NO, the CYL, and/or the NC ports.

In a de-energized state such as when no current is applied to the solenoid, incoming liquids and/or gases can flow in through the NO port 107, circulate within the NO port 107, and flow out via the CYL port 108. In an energized state such as when a current is applied to the solenoid, the seat 111 inside the valve body 102 can move to seal the NO port 107 such that incoming liquids and/or gases can flow in through the NC port 109, circulate within the NC port 109, and flow out via the CYL port 108.

FIG. 1B illustrates an expanded view of box A in FIG. 1A. When the cartridge valve plugs into the manifold, the O-rings 110 in the grooves ensure a tight seal with the manifold. FIG. 1C illustrates a simplified line drawing of box B in FIG. 1B. The O-ring 110 protrudes out from the groove to ensure the seal between the inner wall of the manifold and the valve body.

### Compliant Manifolds

A compliant manifold includes at least one valve receptacle to seat and control fluid flow to and/or from the cartridge valves. In some embodiments, the manifolds have three valve receptacles, and each of the valve receptacles seats and engages the NC port, the CYL port, and the NO port of the cartridge valve, respectively.

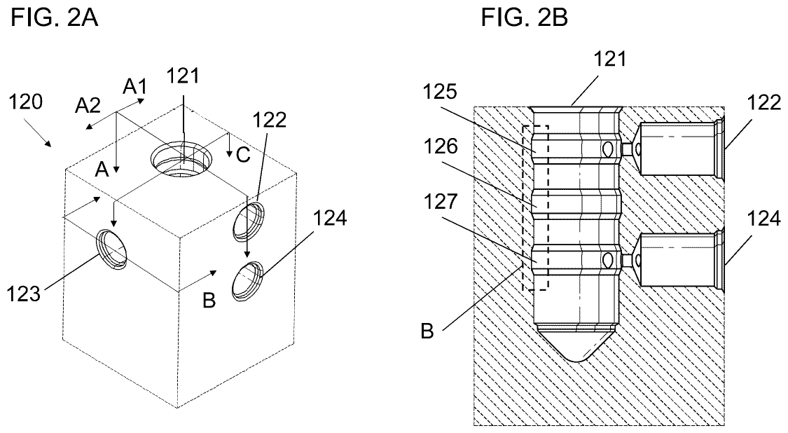

FIG. 2A illustrates an additive manufactured manifold for receiving a cartridge valve in accordance with an embodiment. The manifold 120 can be additive manufactured and optionally post processed with processes such as (but not limited to) machining, heat treatment, and/or any other post processes that can achieve the desired manifold structures and/or the desired mechanical properties. The manifold 120 has a central cavity 121, also referred to as cavity with annular walls. The cartridge valve can be plugged into the cavity 121. The manifold 120 has three main fluid lines, 122, 123, and 124, connecting to the cavity 121. The main fluid lines can be positioned in different directions (for example, aligned (not shown), or misaligned (as shown)) to achieve an efficient and compact manifold structure. The main fluid line 122 can engage with the NO port 107, the main fluid line 123 can engage with the CYL port 108, and the main fluid line 124 can engage with the NC port 109.

FIG. 2B illustrates a cross section view along line A towards the A1 direction of the manifold shown in FIG. 2A in accordance with an embodiment. The central cavity 121 and the main fluid lines 122 and 124 are shown. The inner surface of the annular walls is shaped to engage and lock the cartridge valve in place. The cavity 121 has three valve receptacles 125, 126, and 127. Each valve receptacle connects with a main fluid line: 125 connects with 122, 126 connects with 123 (not shown), and 127 connects with 124. The ports of the cartridge valve seat and engage with the valve receptacles. For example, the NO port 107 engages with 125, the CYL port 108 engages with 126, and the NC port 109 engages with 127.

Additive manufactured valve receptacles ordinarily have right angles (angles of) 90° due to the additive manufacturing process. The inventors discovered that a right angle creates a sharp surface that can tear a gasket (for example, an O-ring 110) between the cartridge valve and the manifold. More specifically, when installing the cartridge valve into the manifold, the gaskets on the valve body slide against the inner wall of the manifold, and the sharp surfaces of the ordinarily printed valve receptacles can tear a gasket.

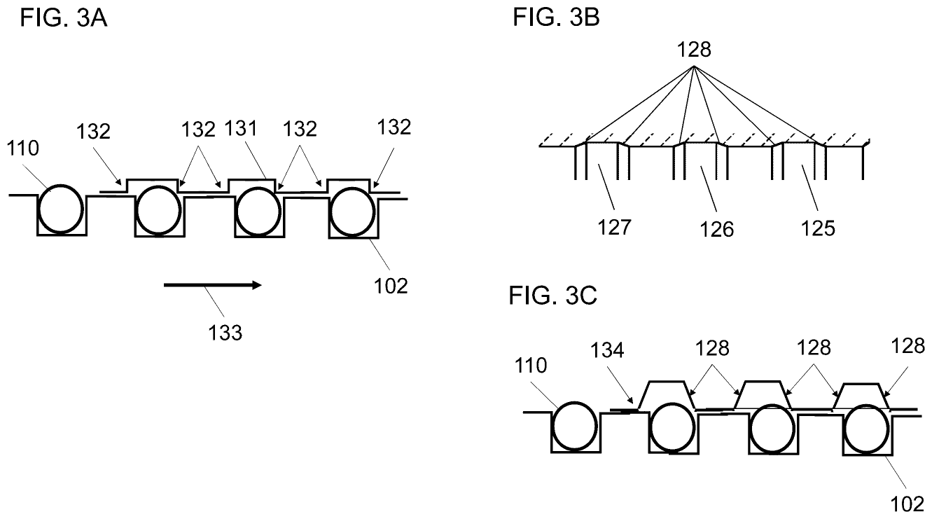

FIG. 3A illustrates a schematic of a manifold with sharp surfaces in contact with the O-rings. A simplified line drawing of a portion of the manifold cavity 131 shows the valve receptacles with sharp surfaces 132. When the cartridge valve body 102 with O-rings 110 slide 133 into the manifold cavity 131, the sharp surfaces 132 of the valve receptacles can tear the O-rings 110 and may cause damage and lead to poor sealing and fluid leakage.

The inventors made the inventive realization that including sloped ridges for the valve receptacles could reduce and/or eliminate gasket tearing. The gradually sloped ridges have obtuse angles (angles greater than) 90° that can increase the height and the contact area between the gaskets and the walls of the manifold cavity. The sloped ridges can prevent tearing of the gaskets in the cartridge valves. FIG. 3B illustrates an expanded view of box B in FIG. 2B. FIG. 3C illustrates a manifold with sloped valve receptacles and the interaction with O-rings in accordance with an embodiment. FIG. 3B shows the valve receptacles 125, 126, and 127 have sloped ridges 128. The sloped ridges 128 have obtuse angles 134 and increased height and surface area. When the cartridge valve body 102 slides into the manifold cavity, the sloped ridges 128 have a greater contact area compared to the sharp surfaces 132 such that the O-rings 110 can roll over the sloped ridges 128 to prevent damage to the O-rings 110.

The inventors discovered that increasing the surface area to solve the problem of protecting the gaskets from tearing and/or damage when the cartridge valve slides into the manifold engenders a new problem: reducing the flow area for the main fluid lines. The fluid flow into the manifold needs to maintain a desired pressure and/or speed. A reduced flow area may not be able to supply the desired fluid flow to the cartridge valve. This problem shows the non-obviousness of selecting the cartridge valves described above and, in fact, the unexpected problems and non-obviousness of selecting 3d printing technology for building manifolds ab initio.

The inventors discovered a solution, however, that allowed them to maintain the desired pressure and/or fluid speed while providing a configuration that reduces the risk of gasket tearing. In this regard, many embodiments implement a plurality of sub-fluid lines connecting the main fluid lines and the valve receptacles to compensate for the reduced flow area. Each valve receptacle connects to at least two sub-fluid lines; or at least three sub-fluid lines; or at least four sub-fluid lines; or at least five sub-fluid lines. The number of sub-fluid lines for each valve receptacle can vary as long as the total flow pressure and/or flow speed from the valve receptacle meets the requirement. The sub-fluid lines can have various shapes and structures. In accordance with many embodiments, the cross section of a sub-fluid line can have various geometries. In some such embodiments, the fluid lines have a cross section geometry in the shape of a circle, an ellipse, and/or a teardrop shape. In many embodiments, the number and the geometry of the sub-fluid lines can be design choices in order to achieve the desired fluid flow requirements of the manifold and the cartridge valve.

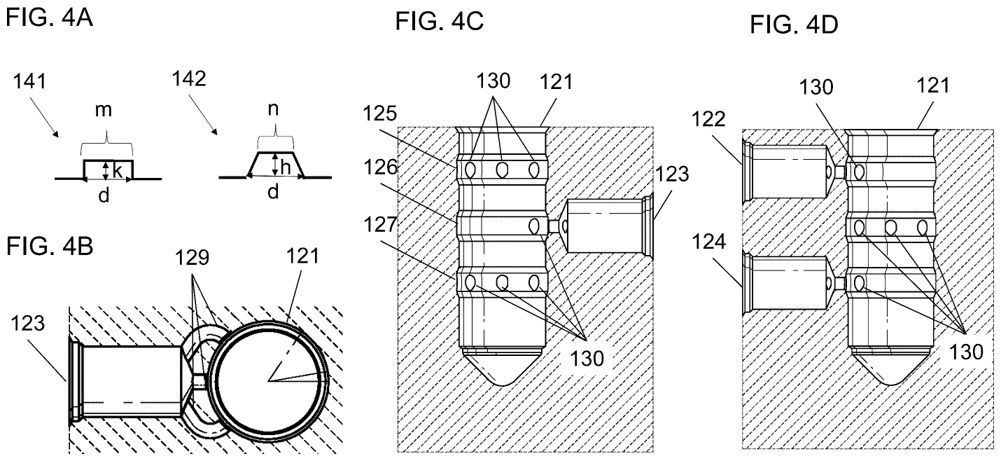

FIG. 4A illustrates a comparison between the sharp surface and the sloped ridge valve receptacles in accordance with an embodiment. The distance d of the valve receptacles can be determined by the size of the cartridge valve. In order to prevent damage to the gaskets, the sloped ridge valve receptacles raise the height h of the receptacles. The height h of the sloped ridge receptacles is greater than the height k of the sharp surface receptacles. With the distance d being the same and the height difference, the surface area m of the sharp surface valve receptacle 141 is greater than the surface area n of the sloped ridge valve receptacle 142. The manifold with the sloped ridges has a smaller surface area n for fluid flow compared to the manifold with the sharp surfaces.

In order to achieve the desired fluid flow, the main fluid lines of the manifold in accordance with many embodiments utilize a plurality of sub-fluid lines. FIG. 4B illustrates a cross section view along line B of the manifold shown in FIG. 2A in accordance with an embodiment. FIG. 4C illustrates a cross section view along line C of the manifold shown in FIG. 2A in accordance with an embodiment. FIG. 4D illustrates a cross section view along line A towards A2 direction of the manifold shown in FIG. 2A in accordance with an embodiment.

Each of the main fluid lines 122, 123, and 124 has three sub-fluid lines 129 connecting to the respective valve receptacles 125, 126, and 127 on the cavity 121 wall. The sub-fluid lines for each main fluid line can have identical structures, lengths, bends, and cross sections. There are three sub-fluid lines (not shown) connecting between the main fluid line 122 and the valve receptacle 125, where it engages with the NO port 107. There are three sub-fluid lines 129 connecting between the main fluid line 123 and the valve receptacle 126, where it engages with the CYL port 108. There are three sub-fluid lines (not shown) connecting between the main fluid line 124 and the valve receptacle 127, where it engages with the NC port 109. The three sub-fluid lines 129 can have the same or different cross sections. Each of the three sub-fluid lines 129 has a smaller diameter than the main fluid line 123 to adapt to the smaller surface area of the valve receptacle 126 with sloped ridges. Even though the sub-fluid lines 129 are smaller, a total fluid flow of the three sub-fluid lines 129 can compensate the reduced flow area due to the sloped ridges of the valve receptacles.

The openings 130 for the sub-fluid lines on the valve receptacles have the same shape and size. In this example, the openings 130 have a tear drop shape. Three sub-fluid line openings 130 of the valve receptacles 125 and 127, and one sub-fluid line opening 130 of the valve receptacle 126 are shown in the cross section view in FIG. 4B. As the main fluid lines 122 and 124 align with each other (FIG. 4D), the three sub-fluid line openings of the valve receptacle 125 and the three sub-fluid line openings of the valve receptacle 127 are also aligned. The main fluid line 123 is positioned at a 90° rotation from the main fluid lines 122 and 124 (FIG. 2A). One of the three sub-fluid line openings of the valve receptacle 126 aligns with one of the three sub-fluid line openings of each of the valve receptacle 125 and 127. Three sub-fluid line openings 130 of the valve receptacle 126, and one sub-fluid line opening 130 of each of the valve receptacle 125 and 127 are shown in the cross section view in FIG. 4C. One of the three sub-fluid line openings of each of the valve receptacles 125 and 127 aligns with one of the three sub-fluid line openings of the valve receptacle 126.

As noted above, selecting the unobvious technology of 3d printing creates a problem when a printed manifold is used with a cartridge valve: the edges of 3d printed valve receptacles are sharp and can tear the gasket(s) of the cartridge valve. Solving that problem by tapering the edges creates a new problem: limiting the flow area. That problem ordinarily would have led away from 3D printing the manifold or using a cartridge valve in combination with a 3D printed manifold. Yet, the inventors were able to overcome the problem by increasing the number of sub-fluid lines passing into a port. Instead of one fluid line passing into the inlet for example, there can be three (or more), depending on flow requirements. Different flow requirements would change the number and dimension of the sublines.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. For example, while the problems and solutions described above are relevant to 3D printing, the inventive designs in this application can be utilized in manifolds that are not 3D printed. And all embodiments of the invention do not need to overcome all problems described above. Embodiments may have sloped edges without increasing the number of sub-fluid lines. Embodiments may have plural sub-fluid lines without using sloped edges. And embodiments of a manifold do not require use with cartridge valves. The embodiments described herein can be utilized with other valves. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A fluid manifold, comprising:
a cavity having an annular wall;
a plurality of valve receptacles each comprising a sloped ridge disposed within the annular wall and at least one fluid opening disposed along the sloped ridge; and
a plurality of main fluid lines, each of the plurality of main fluid lines in fluid communication with one of at least one fluid opening of at least one of the plurality of valve receptacles via at least one of a plurality of sub-fluid lines, the plurality of sub-fluid lines being in fluid communication therebetween;
wherein the fluid manifold is configured for additive manufacturing and the sloped ridge is compliant with a design-for-additive-manufacturing constraint.

2. The fluid manifold of claim 1, wherein at least one of the plurality of valve receptacles is configured to engage with a cartridge valve and seat the cartridge valve when the cartridge valve is disposed within the cavity.

3. The fluid manifold of claim 2, wherein the cartridge valve is further configured to lock in place when engaged by at least one of the plurality of valve receptacles.

4. The fluid manifold of claim 2, wherein the cartridge valve comprises a plurality of ports and each of the at least one fluid opening of the plurality of valve receptacles is configured to engage with at least one of the plurality of ports.

5. The fluid manifold of claim 1, wherein the fluid manifold comprises three valve receptacles and three main fluid lines.

6. The fluid manifold of claim 1, wherein each of the main fluid lines is in fluid communication with three sub-fluid lines.

7. The fluid manifold of claim 2, wherein the cartridge valve further comprises a gasket and at least one sloped ridge is configured to reduce damage to the gasket.

8. The fluid manifold of claim 1, wherein the fluid manifold is configured for a fluid flow selected from the group consisting of a liquid flow, a gaseous flow, or a mixture of a liquid flow and a gaseous flow.

9. The fluid manifold of claim 8, wherein the fluid flow comprises a fluid selected from the group consisting of: a liquid fuel for engines or launch vehicles, a gaseous fuel for engines or launch vehicles, an igniter gas for engines, an inert gas, a cooling liquid, a cooling gas, a cryogenic liquid, a cryogenic gas, a cryogenic inert gas, liquid oxygen, cryogenic liquid oxygen, liquid hydrogen, cryogenic liquid hydrogen, kerosene, hydrazine, and hydrogen peroxide.

10. An article comprising:
a central cavity having a plurality of annular cavity walls disposed around a central axis, wherein the plurality of annular cavity walls are disposed at a first radial distance from the central axis;
at least one valve receptacle recessed within the central cavity, the at least one valve receptacle comprising an annular receptacle wall disposed at a second radial distance from the central axis, the second radial distance being greater than the first radial distance;
the at least one valve receptacle further having a pair of annular sloped ridges connecting the annular receptacle wall of the at least one valve receptacle with at least one adjacent annular cavity wall;
a plurality of fluid openings disposed in the annular receptacle wall of the at least one valve receptacle, each fluid opening having a teardrop cross-section oriented such that an axis of the teardrop cross-section is arranged in a direction parallel to the central axis of the central cavity; and
a plurality of sub-fluid lines in fluid communication between the plurality of fluid openings and at least one main fluid line.

11. The article of claim 10, wherein at least one of the plurality of sub-fluid lines is co-axial with the at least one main fluid line.

12. The article of claim 10, wherein at least one of the plurality of sub-fluid lines is disposed along a curved path between the at least one main fluid line and the central cavity.

13. The article of claim 10, wherein the at least one main fluid line is configured with a uniform cross-section geometry across a length of the at least one main fluid line.

14. The article of claim 10, wherein the at least one main fluid line is configured with a cross-section geometry selected from the group consisting of: teardrop shape, circular, ovular, and polygon.

15. The article of claim 10, wherein a degree of slope of an edge of the teardrop cross-section is compliant with a design-for-additive-manufacturing constraint.

16. The article of claim 10, wherein a degree of slope of the pair of annular sloped ridges is compliant with a design-for-additive-manufacturing constraint.

17. The article of claim 10, wherein each of the plurality of fluid openings spans substantially all of the annular receptacle wall between the annular sloped ridges.

18. The article of claim 10, further comprising a cartridge valve configured to be inserted in and disposed within the central cavity.

19. The article of claim 17, wherein the cartridge valve comprises a port and the cartridge valve and the central cavity are further configured such that the port of the cartridge valve is aligned opposite the valve receptacle when the cartridge valve is disposed within the central cavity.

20. A fluid manifold, comprising:
a cavity having an annular wall;
three valve receptacles each comprising a sloped ridge disposed within the annular wall and at least one fluid opening disposed along the sloped ridge;
three main fluid lines each in fluid communication with one of the at least one fluid opening of at least one of the three valve receptacles via at least one of a plurality of sub-fluid lines, the plurality of sub-fluid lines being in fluid communication therebetween; and
a cartridge valve comprising a plurality of ports and at least one gasket;
wherein each of the three valve receptacles is configured to engage with the cartridge valve and seat the cartridge valve when the cartridge valve is disposed within the cavity, each of the at least one fluid opening is configured to engage with at least one of the plurality of ports, the cartridge valve is configured to lock in place when engaged by at least one of the three valve receptacles, and each sloped ridge is configured to reduce damage to the at least one gasket.
